(19) United States
(12) Patent Application Publication
(10) Pub. No.: US 2014/0299490 A1
(43) Pub. Date: Oct. 9, 2014

(54) Package for a Medicament

(71) Applicant: THE PROCTER & GAMBLE COMPANY, Cincinnati, OH (US)

(72) Inventors: Frank Delmar Macaulay, Cincinnati, OH (US); Jason Michael Hargis, Bellevue, KY (US); Nicholas August Vitucci, Cincinnati, OH (US)

(73) Assignee: The Procter & Gamble Company, Cincinnati, OH (US)

(21) Appl. No.: 13/856,710

(22) Filed: Apr. 4, 2013

(51) Int. Cl. A61J 1/16; A61J 1/03; A61J 1/14

(52) U.S. Cl. CPC A61J 1/16; A61J 1/1412; A61J 1/03
USPC 206/216; 206/438; 206/528

(57) ABSTRACT

An outer package for a medicament is provided. The outer package has a front face, a back face, a first side, a second side, a top, and a bottom. The outer package has an interior and an exterior, the interior containing an inner package containing a medicament. The top is provided at an angle with respect to the front face of the package when the package is sealed, and has an opening suitable for extending a portion of the inner package therethrough when the package is sealed.

### FIELD OF THE INVENTION

The application relates to an improved package for a medicament, and more particularly to an improved outer package for containing an inner package containing a medicament.

### BACKGROUND OF THE INVENTION

Consumer products are often marketed to consumers at the point of sale in protective packaging, such as boxes, containers, bags, blister packs, cartons, and the like. In addition to being protective, packaging for consumer products can allow consumers to determine accurate information about a product from looking at and/or handling the packaging.

In some instances, packaging for a consumer product can include images and/or words describing the product contained within the package. For example, the packaging can include a brand name, product type, instructions for use, and the like. Although the packaging may include such indicia, consumers may not spend a great deal of time looking at a package, and in some instances, may not be able to quickly confirm that a given package, such as, for example, a closed box, contains the product that they wish to purchase.

As such, there remains a need for packaging that has structural features that help a consumer determine attributes of the product inside the package. There also remains a need for packaging that can display one or more different types of products contained within the package at the same time.

### SUMMARY OF THE INVENTION

An outer package for a medicament is provided. The outer package has a front face, a back face, a first side, a second side, a top, and a bottom. The outer package has an interior and an exterior, the interior containing an inner package containing a medicament. The top is provided at an angle with respect to the front face of the package when the package is sealed, and has an opening suitable for extending a portion of the inner package therethrough when the package is sealed.

An outer package for a medicament is also provided. The outer package has a front face, a back face, a first side, a second side, a top, and a bottom. The package has an interior and an exterior, the interior containing a first inner package containing a first medicament. The top is provided at an angle with respect to the front face of the package when the package is sealed, and has an opening suitable for extending a portion of the first inner package therethrough when the package is sealed. In addition, the interior has a second inner package containing a second medicament, and the second inner package is not visible to a consumer viewing the sealed package.

Also provided is an outer package for a medicament. The outer package has a front face, a back face, a first side, a second side, a top, and a bottom. The front face, the back face, the top and the bottom are generally in the shape of a rectangle, and the front face having a height that is less than a height of the back face. The package has an interior and an exterior, the interior containing a bottle containing a liquid medicament, and the bottle has a lid. The top is provided at an angle with respect to the front face of the package when the package is sealed, and the lid is extended through an opening in the top such that the lid is external to the outer package and is viewable by a consumer when the package is sealed.

### DETAILED DESCRIPTION OF THE INVENTION

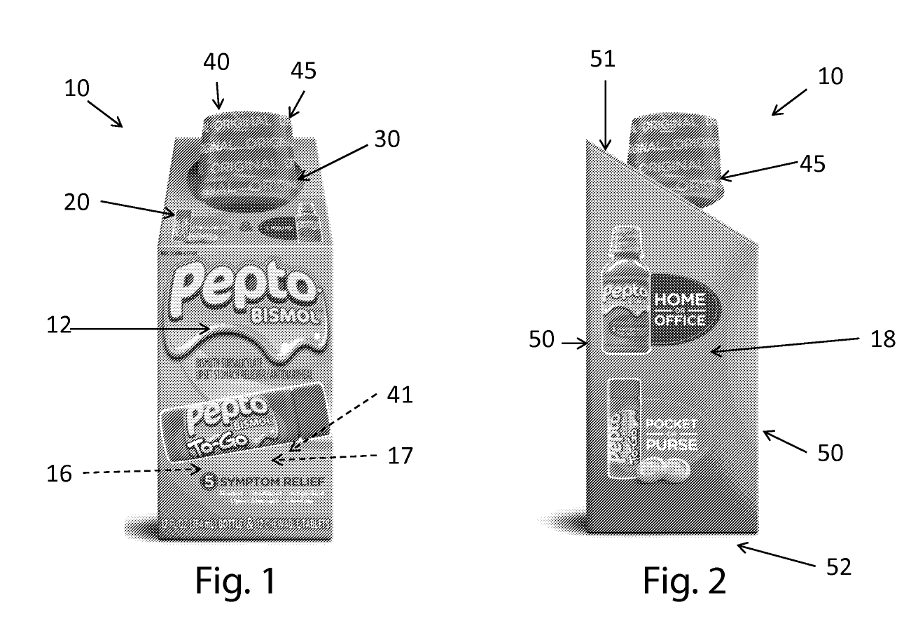

FIG. 1 is a front view of a package for a medicament.

FIG. 2 is a side view of the package shown in FIG. 1.

### DETAILED DESCRIPTION OF THE INVENTION

The present invention relates to an improved package for a medicament, wherein the package has at least one angled face, such as, for example, an angled top face. The package can be configured to enclose only a portion of an interior package, such as a bottle of liquid medication, and at least a portion of the interior package, such as a lid, can extend out of the outer package. In this configuration, the lid may be readily identifiable by a consumer as a lid for a bottle of liquid medication, such as, for example, by the inclusion of a dosing cup on the lid. In addition, the package can be configured to enclose a portion of an interior package that can be a bottle of liquid medication and an interior package that can be a portable container of medication. The portable container of medication can contain a solid medication, such as, for example, a chewable medication or a tablet or capsule. In certain scenarios, the liquid medication and the solid medication can have the same active ingredient.

Typically, medication, such as liquid medication or solid medication, such as tablets or capsules, can be packaged in a bottle or container. The bottle or container can be sold directly to the consumer, or can be packaged in an outer package, such as a box, clear wrap, sleeve, or other suitable package. In instances where the bottle or container is packaged in a box for sale, the consumer may be unable to see the bottle or container of medication before purchase and may be unable to quickly determine if the box contains the desired medication form. In contrast, when the consumer can view the bottle or container, the consumer can quickly see which form of medication is provided, especially in the instance where liquid medication is viewable through the body of a bottle and/or where the bottle is provided with a dosing cup on the lid.

The outer package described herein is configured to enclose an inner package of medication, where a distinguishing portion of the inner package, such as, for example, the lid and/or dosing cup of a bottle for liquid medication, protrudes from the interior of the package to the exterior of the package. In some scenarios, the portion of the inner package that is visible to a consumer prior to purchase can be distinctive such that the consumer can more easily identify the medication form contained within the package. For example, in one scenario, the exterior package encloses a bottle of liquid medication that includes a recognizable lid, including a dosage cup and a distinctive color. The lid protrudes from the exterior package such that it can be seen by a consumer viewing the exterior package.

In some instances, the exterior package can also contain a second container that is completely contained within the exterior package such that the second container is not visible to a consumer. The first container and the second container can have the same medication or different medications, and can be in the same form or different forms, such as, for example, a liquid medication and a solid medication. In addition, the first container and the second container can include medications suitable for treating the same class of symptoms, such as, for example, respiratory symptoms, digestive symptoms, or other symptoms suitable for treatment with a medicament. Because the second container is not visible to a consumer, its presence in the outer container can be shown via indicia on the exterior of the package, such as, for example, by a visual depiction of the second container and/or the medication contained therein.

FIG. 1 shows the front face of a package 10. The package 10 can be a box, and can be made of any suitable material, such as paper, cardboard or laminates of packaging materials. Package 10 can be any suitable shape or size, and can be a six-sided box having four sides or faces, a top and a bottom. FIG. 1 shows one face 12 of a six-sided box, the face shown having four edges generally in the shape of a square, the edges being at the corners of a three-dimensional package 10. FIG. 1 also shows top 20 of the box. As shown in FIG. 1, top 20 can have four edges generally in the shape of a square, and can be provided at an angle such that the top 20 is visible when viewing face 12. Top 20 can also have opening 30, which can be in a shape suitable for extending a portion of product 16 therethrough. As shown in FIG. 1, opening 30 can be in the shape of a circle.

The product 16 contained within package 10 can be contained within an inner package 40. As shown in FIG. 1, inner package 40 can be a bottle, such as, for example, a bottle containing a liquid medicament. The bottle can have a lid 45 that protrudes through opening 30 when the package is sealed. The lid 45 can include a dosing cap suitable for measuring a dose of the liquid medicament contained within the bottle. As shown in FIG. 1, at least one side of the lid 45 can protrude substantially entirely from top 20 of package 10. Such a configuration can allow a consumer to readily identify that the package 10 contains a bottle for a liquid medicament. This can assure the consumer that they are purchasing the desired liquid medicament, despite the body of the bottle being enclosed within the package 10.

In addition, certain medicaments may be associated with a particular color, and lid 45 can be colored, such as, for example, via use of a pigmented material or by covering or wrapping the lid with the particular color, which can also indicate to a consumer that they are purchasing the correct medication form. In some instances, the exposed portion of the inner package can be made even more visually discernible to a consumer by applying a contrasting color and/or pattern to some or all of the top face of the outer package. This can allow the top face to act as a background to highlight the distinguishing feature of the inner package viewed by the consumer.

One or more indicia may be provided on face 12 and/or top 20 of the package 10 that correspond to the first product 16 and/or the first inner package 40. Suitable indicia could depict, for example, a visual of first product 16 and/or first inner package 40. Alternatively, the first product 16 and/or first inner package 40 may not be depicted on the exterior surface of package 10.

Package 10 can also include a second product 17 that can be contained within a second inner package 41. As shown in FIG. 1, the second product 17 and second inner package 18 may not be visible when package 10 is sealed. One or more indicia may be provided on face 12 of the package 10 that correspond to the second product 17 and/or the second inner package 41. Suitable indicia could depict, for example, a visual of second product 17 and/or second inner package 41. As shown in FIG. 1, because the second product 17 or second inner package 41 is not visible through the package 10, it may be desirable to place an indicia depicting the second product 17 and/or second inner package 41 in a prominent position on face 12, such as, for example, at a slight angle on face 12.

FIG. 2 shows the side face 18 of package 10. The side face 18 has four edges generally in the shape of a quadrilateral, the edges being at the corners of a three-dimensional package 10. The side edges 50 are generally parallel to one another, and the top edge 51 is not parallel to the bottom edge 52, such that the top edge 51 forms an angled surface that corresponds to top 20. As shown in FIG. 2, the back face of package 10 can be taller than the front face 12 to form the angled surface of top edge 51. As shown in FIG. 2, side face 18 can include indicia corresponding to the first product 16, first inner package 40, second product 17, and/or second inner package 41.

The top face of the package is angled such that the face is viewable to a consumer viewing the front face of the package. For example, the top face can be angled such that substantially the entire top face and the entire front face can be viewed by a consumer when the package is placed on a store shelf. In one embodiment, the top face is angled such that a consumer can view the top face, the portion of the inner package protruding therefrom, and the front face of the package at the same time. The top face can have any suitable angle with respect to the front face of the package, such as, for example, about 20 degrees to about 80 degrees, such as about 30 degrees to about 70 degrees, about 40 degrees to about 60 degrees, about 40 degrees to about 50 degrees, or about 45 degrees.

The package may be any suitable shape, such as for example, with a bottom portion that is generally rectangular or generally square. The top portion can be configured in any suitable shape for providing the desired angled surface, such as, for example, in a triangular shape as viewed from the side. The top face can be provided in the form of a top flap, such that the flap can be folded over the exposed portion of the inner package and sealed to close the container. In addition, the package can include side flaps connected to opposing faces of the package that can be folded toward each other and toward the center of the package. In certain configurations, the side flaps can be folded toward each other and the top flap can be folded over the side flaps and the exposed portion of the inner package to form the top face and close the package.

The package may be any suitable size, such as, for example, a size appropriate for housing one or more inner packages of medication. For example, in one scenario, the package front face can be from about 4 inches to about 5 inches tall and from about 2 to about 3 inches wide, the back face can be from about 6 inches to about 7 inches tall and from about 2 to about 3 inches wide, each side face can be from about 4 inches to about 5 inches tall at the front of the side face and from about 6 inches to about 7 inches tall at the back of the side face, and the top face can be from about 3 to about 4 inches as measured from the front face to the back face and from about 2 to about 3 inches wide.

The package has an opening suitable for allowing a distinctive portion of the inner package to protrude therethrough. The opening can be any suitable shape, such as, for example, circular, square, rectangular, oval, triangular, flower shaped, heart shaped, or any other suitable shape. The opening can be any suitable size, such as, for example, from about 0.5 inches to about 3 inches, such as, for example, from about 0.5 inches, about 0.7 inches, about 1 inch, about 1.2 inches, about 1.4 inches, about 1.6 inches, about 1.8 inches, about 2.0 inches, about 2.2 inches, about 2.4 inches, about 2.6 inches, about 2.8 inches, about 3.0 inches, or any other suitable size. The opening can be any suitable percentage of the area of the top face, such as, for example, from about 10% to about 90% of the area, from about 20% to about 80% of the area, from about 30% to about 70% of the area, from about 40% to about 60% of the area, or any other suitable amount of the area.

The inner package can be any suitable container for a medicament. For example, suitable containers for liquid medications can include bottles, including bottles with lids, lids with dosing cups, droppers, or the like. The bottle can be transparent on all or a portion of the body, such that the liquid medication can be viewed through the bottle prior to use. Bottles for liquid medication can be asymmetric along a transverse axis, such as, for example, with an oval, round, square, rectangular, or triangular body and a narrowed neck and lid. Suitable containers for solid medications can include, for example, bottles, jars, or “to go” containers suitable for carrying a small number of chewables, tablets, or capsules, and the like. Containers for solid medication can be opaque, such that the medication cannot be viewed within the container, and may be generally symmetric about a transverse axis. Solid medication can also be contained in a typical blister card or pack.

A portion of the inner package can be contained within the outer package, and a portion of the inner package can protrude through a face of the outer package to the exterior of the package. In certain scenarios, the exposed portion of the inner package can be a portion with a distinguishing feature. For example, if the inner package is a bottle for a liquid medicament, the cap of the bottle can be the exposed portion. The cap can include a dosage cup or other identifying indicia. Any suitable amount of the inner package can be exposed, such as, for example, about 10% to about 30%, about 15% to about 25%, or any other suitable amount.

The outer package also can include a second inner package of medication. The second inner package can be a different package type from the first inner package, such as, for example, where the first inner package is a bottle for a liquid medicament and the second inner package is a container for a solid medicament. In some scenarios, the first inner package can be a full size bottle or container and the second inner package can be a travel size bottle or container. The first inner package and the second inner package can contain the same medicament, such as, for example, an anti-diarrheal or a cold and flu medicament. Alternatively, the first inner package and the second inner package can contain different medicaments, such as, for example, a heartburn medicament and an anti-diarrheal medicament or a daytime cold medicament and a nighttime medicament. In some scenarios, the first inner package and the second inner package can contain medicaments appropriate for treating the same category of condition, such as, for example, respiratory disorders, digestive disorders, or any other suitable category of conditions.

The outer package can be displayed to a consumer alone, or together with other forms of the medication. For example, in one scenario, the outer package can contain an inner package that is a bottle for a liquid anti-diarrheal medication and a container for a solid anti-diarrheal medication. The outer package can be displayed on a store shelf or via a website near the bottle and/or the container as they are individually sold. The bottle and/or the container could be sold without any outer packaging, which could facilitate the consumer more readily identifying the distinguishing portion of the inner package that protrudes from the outer package described herein.

Indicia can be disposed on any face of the outer package, such as, for example, an externally visible face, particularly a face intended to be outwardly oriented with respect to a retail shelf at the point of sale. Indicia can be sized to cover from about 10%, about 20%, about 50% or about 90% of the externally visible face or top of the outer package. In general, indicia can range from about 1 cm to about 10 cm in size, measured in a maximum dimension from one peripheral edge to another.

The medicament can be manufactured in any suitable product form. Suitable product forms include tablets, dragees, caplets, softgel capsules, solid-filled capsules, liquid-filled capsules, enteric-coated forms, sustained-release forms, solid lozenges, liquid-filled lozenges, mouth and throat drops, gums, confectionaries, “gummies”, effervescent tablets, dry dissolvable powders (for example in sachets or stick packs), dissolvable film strips, sublingual tablets, buccal tablets, syrups, elixirs and liquids for swallowing, treats, biscuits, patches for transdermal administration of an active, topical anti-microbial compositions, inhalants, topical creams and lotions, and combinations thereof.

The medicament can be useful for treating a respiratory condition, such as, for example, cold and flu, bacterial infections, allergies, sinusitis, rhinitis, asthma, and the like. Respiratory conditions may present with any of a variety of symptoms, such as runny nose, nasal and/or chest congestion, cough, sneezing, pressure, headache, aches, fever, fatigue and/or sore throat. Actives suitable for treatment of these symptoms can include, for example, decongestants, anti-cholinergics, expectorants, antihistamines, antitussives, analgesics, anti-virals, mucolytics, demulcents, anesthetics, and antibiotics, including, for example, non-prescription pharmaceutical actives and prescription pharmaceutical actives.

The medicament can be useful to treat a gastrointestinal condition, such as, for example, viral infections, bacterial infections, auto-immune conditions, genetic conditions and the like. Gastrointestinal conditions may present with any of a variety of symptoms associated with a disruption in function of the digestive system, such as diarrhea, constipation, upset stomach, vomiting, sour stomach, cramps, gas, bloating, stomach ache, and the like. Actives suitable for treatment of these symptoms can include, for example, laxative, anti-diarrheal, anti-emetic, anti-inflammatory, antacid, rafting agents and anti-flatulent, including, for example, non-prescription pharmaceutical actives and prescription pharmaceutical actives.

The medicament can be useful to treat any other suitable condition, such as, for example, overall health and well-being, including, for example, respiratory health, gastrointestinal health, immune health, mobility and joint health, cardiovascular health, skin health, oral/dental health, hair health, eye health, reproductive health (including menstrual health), ear, nose and throat health, and the like.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An outer package for a medicament, the outer package comprising a front face, a back face, a first side, a second side, a top, and a bottom, the package having an interior and an exterior, the interior containing an inner package containing a medicament, the top being provided at an angle with respect to the front face of the package when the package is sealed, the top having an opening suitable for extending a portion of the inner package therethrough when the package is sealed.

2. The outer package of claim 1, wherein the inner package is a bottle for a liquid medicament.

3. The outer package of claim 1, wherein the lid of the inner package extends through the opening when the package is sealed.

4. The outer package of claim 3, wherein the lid includes a dosing cup.

5. The outer package of claim 1, wherein the angle is from about 20 degrees to about 70 degrees.

6. The outer package of claim 1, wherein the opening is a shape that is less than about 90% of the area of the top.

7. An outer package for a medicament, the outer package comprising a front face, a back face, a first side, a second side, a top, and a bottom, the package having an interior and an exterior, the interior containing a first inner package containing a first medicament, the top being provided at an angle with respect to the front face of the package when the package is sealed, the top having an opening suitable for extending a portion of the first inner package therethrough when the package is sealed, the interior containing a second inner package containing a second medicament, wherein the second package is not visible to a consumer viewing the sealed package.

8. The outer package of claim 7, wherein the first inner package is a bottle for a liquid medicament.

9. The outer package of claim 7, wherein the lid of the inner package extends through the opening when the package is sealed.

10. The outer package of claim 7, wherein the second inner package is a container for a solid medicament.

11. The outer package of claim 7, wherein the first medicament and the second medicament include the same active agent.

12. The outer package of claim 7, wherein an indicia depicting the second inner package is provided on the exterior of the outer package.

13. An outer package for a medicament, the outer package comprising a front face, a back face, a first side, a second side, a top, and a bottom, the front face, the back face, the top and the bottom being generally in the shape of a rectangle, the front face having a height that is less than a height of the back face, the package having an interior and an exterior, the interior containing a bottle containing a liquid medicament, the bottle having a lid, the top being provided at an angle with respect to the front face of the package when the package is sealed, the lid being extended through an opening in the top such that the lid is external to the outer package and is viewable by a consumer when the package is sealed.

14. The outer package of claim 13, wherein the inner package is a bottle for a liquid medicament.

15. The outer package of claim 13, wherein the lid of the inner package extends through the opening when the package is sealed.

16. The outer package of claim 15, wherein the lid includes a dosing cup.

17. The outer package of claim 13, wherein the angle is from about 20 degrees to about 70 degrees.

18. The outer package of claim 13, wherein the opening is a shape that is less than about 90% of the area of the top.

19. The outer package of claim 13, wherein the outer package further contains a container for a solid medicament.

20. The outer package of claim 19, wherein the liquid medicament and the solid medicament include the same active agent.
